(19) United States
(12) Patent Application Publication
(10) Pub. No.: US 2020/0206976 A1
(43) Pub. Date: Jul. 2, 2020

(54) COMBINED CUTTING AND BEVELLING MACHINE FOR SLABS OF STONE OR STONE-LIKE MATERIAL

(71) Applicant: Dario Toncelli, Bassano del Grappa (VI) (IT)

(72) Inventor: Dario Toncelli, Bassano del Grappa (VI) (IT)

(21) Appl. No.: 16/624,105

(22) PCT Filed: Jun. 20, 2018
(86) PCT No.: PCT/IB2018/054535

§ 371 Date: Dec. 18, 2019

(30) Foreign Application Priority Data
Jun. 23, 2017 (IT) 102017000070652

(51) Int. Cl. B28D 1/00; B28D 1/04; B28D 1/18; B28D 7/04

(52) U.S. Cl. CPC B28D 1/003; B28D 1/043; B28D 1/30; B28D 7/04; B28D 1/186

(57) ABSTRACT

A combined cutting and bevelling machine (10) for slabs of stone or stone-like material comprises a workpiece support bench (30) and a work unit (16) provided with a cutting unit (50) and a bevelling unit (40), wherein the cutting unit (50) comprises a cutting spindle (51) and the bevelling unit (40) comprises a bevelling spindle (41).

The present invention relates to a combined cutting and bevelling machine for slabs of stone or stone-like material.

In particular, the present invention relates to the technical sector for obtaining bevelled tiles by means of cutting from a larger slab.

In the present description, for the sake of easier description, the term “slab” will be used to indicate a rough element which is yet to be cut into strips or tiles, the term “strip” will be used to indicate a strip of material which will then be cut into tiles, and the term “tile” will be used for a generally smaller element obtained by cutting the slab or strip. “Tile” will therefore also indicate panels having fairly large dimensions. The purpose of said simplification is merely to make reading of this text easier, without however having any limiting effect on the scope of protection offered by the present description.

It is known that there exists a need to obtain slabs which are bevelled and cut-to-size. In fact, the tiles have rough edges such that often the edges of the tile must be chamfered. The chamfer is referred to by the term “bevel” and for example may be inclined at 45 degrees or curved.

A widely used technical solution, by means of which bevelled tiles may be obtained, involves the use of two types of machine in succession: a cutting machine and a bevelling machine which may be arranged in line, but separate from each other.

The cutting machine may be a conventional cutting machine which, for example, may have two lateral support structures above which at least one beam is slidable, resting with its ends on the lateral support structures. A sleeve-holder carriage having, mounted thereon, a vertically sliding sleeve travels along the at least one beam. A machining head with a spindle adapted to be equipped with a diamond cutting disc is mounted on the sleeve. Machines of this type are described for example in patent application WO 2016/071838.

The bevelling machine may instead be provided with a series of inclined-axis pneumatic spindles arranged parallel with each other and equipped with lapping tools able to form the bevel along an edge of the tiles.

The use of these two machines arranged in succession to obtain a finished product has a number of drawbacks. Firstly it is a very costly solution since two separate machines are required. Secondly, it is a solution which is not very efficient since it increases considerably the overall machining time. In fact, in order to pass from one type of machining operation to another one, it is required to remove the material from a machine, move it to another machine and reposition the material. This repositioning of the tiles from the cutting machine to the bevelling machine may also give rise to a loss of precision. Moreover, adjusting the alignment of the bevelling machine with respect to the tiles is further complicated if the parts to be bevelled have dimensions or shapes which are very different from each other.

It has also been noticed that, when the bevel is performed after cutting the slab, if the latter is not performed with extreme precision or if the slab has thicknesses which differ, even slightly, with respect to the nominal thickness, a non-optimum bevel, with dimensional variations along the edge of the tile, will be obtained.

Finally, the movement of the material is an operation which may require the assistance of an operator, which could result in further positioning imprecision and which in any case represents a cost which must be added to the final product.

In order to overcome these drawbacks a composite machine adapted to perform both the cutting operations and the bevelling operations has been developed. In machines of this type, the spindle is equipped with a cutting disc and with an axially mounted bevelling tool which may be attached to or removed from the spindle of the cutting disc by means of a releasable connection. In this way the bevelling tool may be used to form a bevel and then removed so that the slab may be cut with the cutting disc.

This type of machine may also be provided with a guiding device which allows the bevelling disc to perform incisions or pre-cuts in the slab always to the same depth, irrespective as to any irregularities on the surface of the slab, so as to obtain an edge with a regular and uniform bevel.

Machines of this type are described for example in international patent application WO 2015/159270.

However, even these machines, although widely used and popular, are not without drawbacks.

Firstly they have a limited productivity since the bevelling tool must be constantly mounted and removed and this requires machine stoppages which increase the machining time.

Another drawback is that, once the bevelling tool has been removed, it is necessary to align the cutting disc with the cut which has been previously made and this may result in a lack of precision and/or an increase in the manufacturing times for the finished product.

The object of the invention is therefore to overcome substantially the drawbacks of the prior art.

A first task of the present invention is to reduce the times and costs necessary for obtaining strips or tiles with bevelled edges from a slab.

A second task of the present invention is to provide a technology where cutting of the slab and bevelling of the edges of the tile may be performed in a single simple and low-cost combined cutting and bevelling machine.

A third task of the present invention is to provide a technology in which realignment of the cutting disc with respect to the cut previously made by the bevelling disc is no longer required.

Moreover the aim is to provide a combined cutting and bevelling machine which is able to produce a uniform bevel along the whole edge of the tile and/or the strip.

The object and tasks are achieved with a combined cutting and bevelling machine for slabs of stone or stone-like material according to claim 1.

In particular, the invention relates to a machine comprising at least one work unit provided with a cutting unit and a bevelling unit, wherein the cutting unit comprises a cutting spindle and the bevelling unit comprises a bevelling spindle.

Further advantageous characteristic features according to the present invention are indicated in the dependent claims.

The advantages and characteristic features of the present invention will emerge more clearly from the detailed description below of a number of examples of embodiment provided by way of a non-limiting example, with reference to the attached drawings in which:

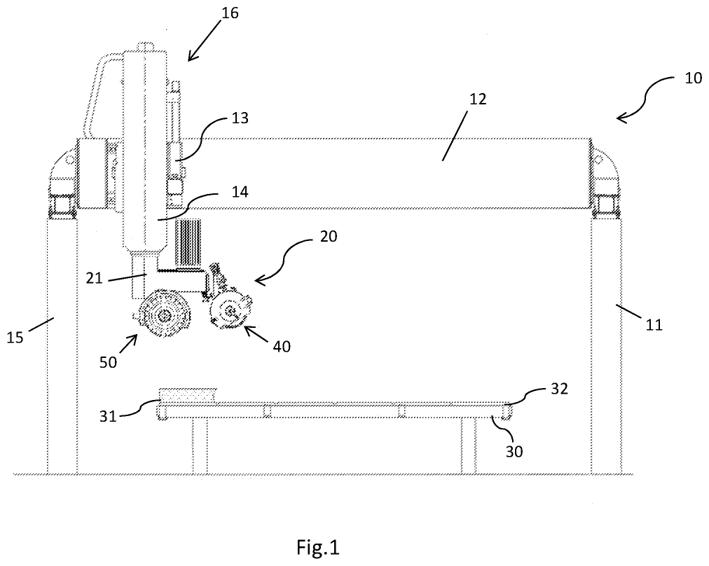

FIG. 1 shows in schematic form a side view of a combined cutting and bevelling machine for slabs of stone or stone-like material according to the present invention;

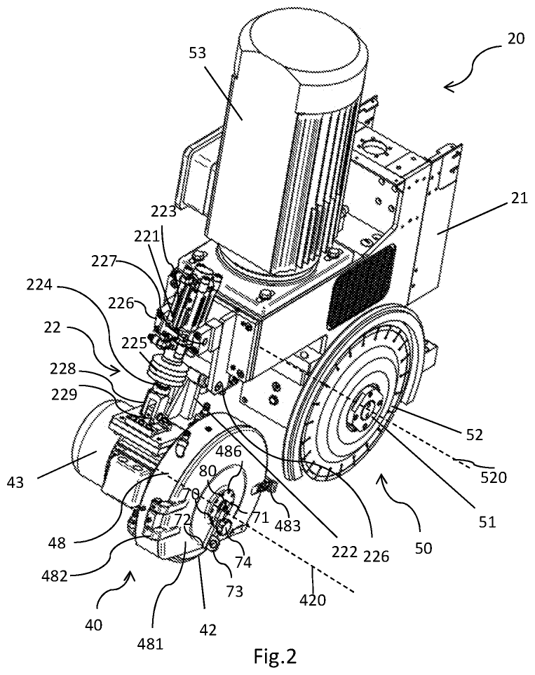

FIG. 2 shows in schematic form a perspective view of a machining head for a combined cutting and bevelling machine according to the present invention;

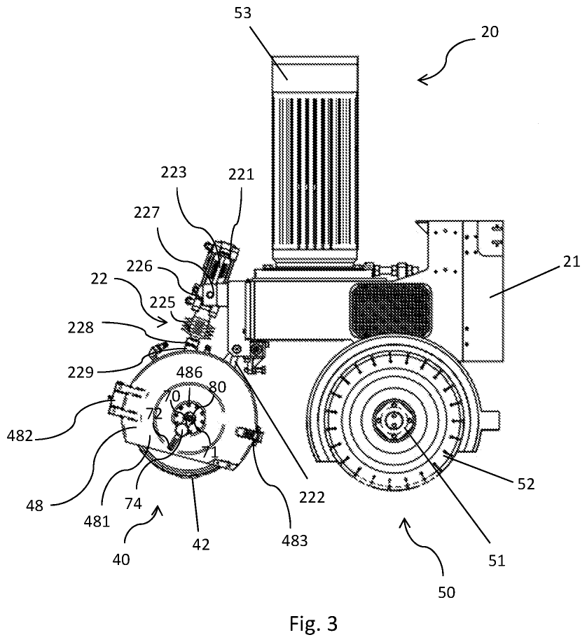

FIG. 3 shows in schematic form a side view of the machining head according to FIG. 2;

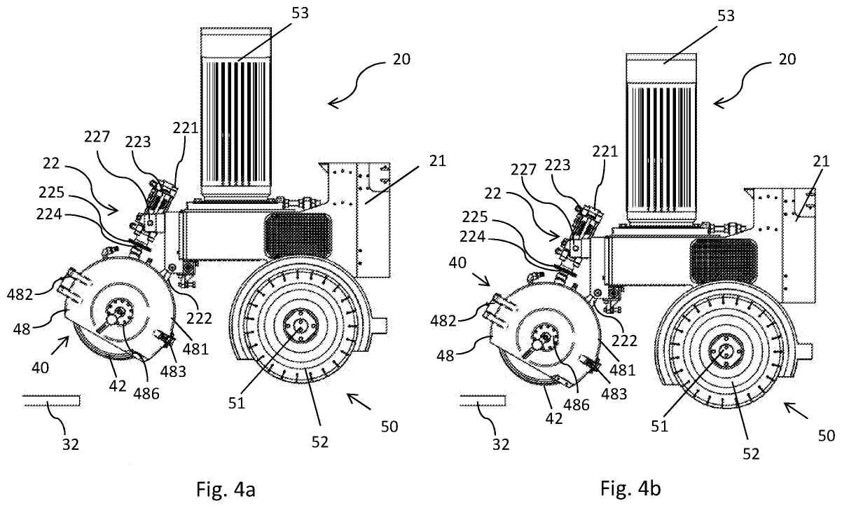

FIG. 4a shows in schematic form a side view of the machining head according to FIG. 2 in a first working configuration;

FIG. 4a shows in schematic form a side view of the machining head according to FIG. 2 in a second working configuration;

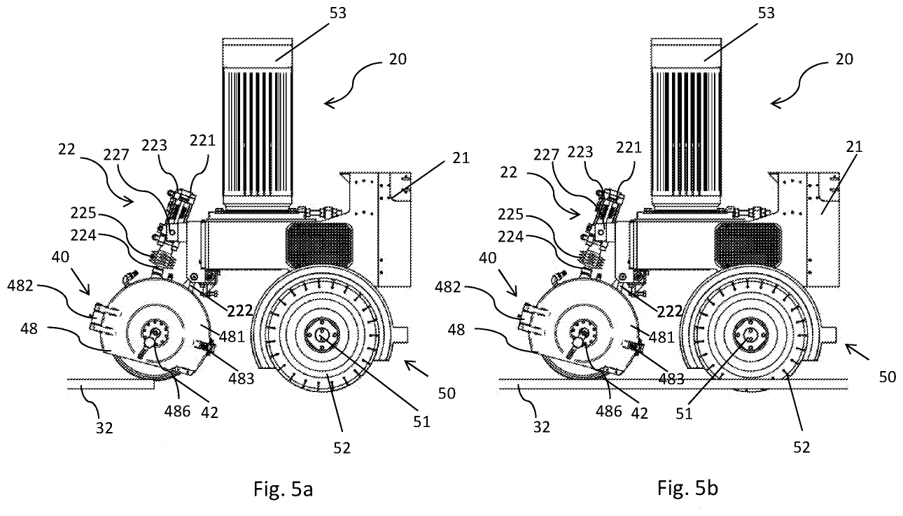

FIG. 5a shows in schematic form a side view of the machining head according to FIG. 2 in a third working configuration during a slab bevelling step;

FIG. 5b shows in schematic form a side view of the machining head according to FIG. 2 in the third working configuration during a combined slab cutting and bevelling step;

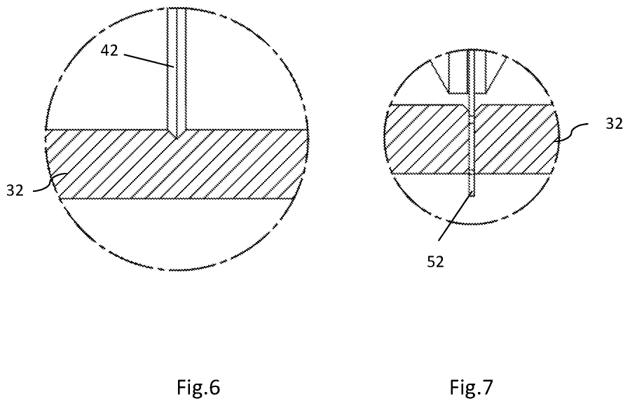

FIG. 6 shows a detail of the bevelling disc during the bevelling step of FIG. 5a;

FIG. 7 shows a detail of the cutting disc during the cutting step of FIG. 5b;

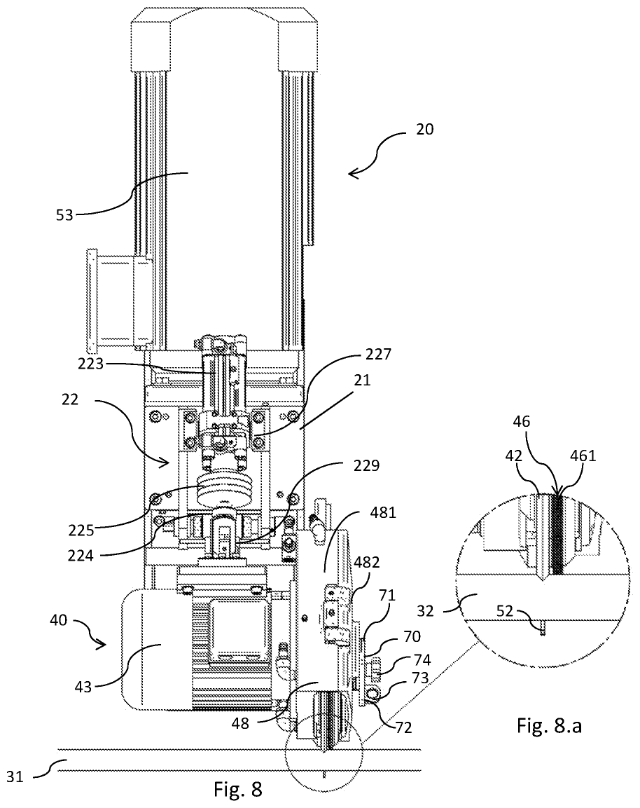

FIG. 8 shows in schematic form a front view of a machining head according to a possible embodiment of the present invention;

FIG. 8a shows a detail, on a larger scale, of the machining head according to FIG. 8;

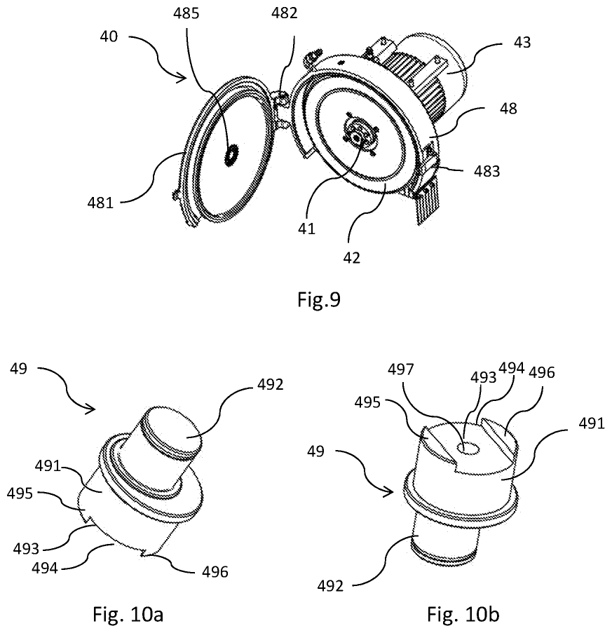

FIG. 9 shows in schematic form a perspective view of a bevelling unit according to a possible embodiment of the present invention;

FIGS. 10a-b shows in schematic form perspective views of a component of the machine according to the present invention;

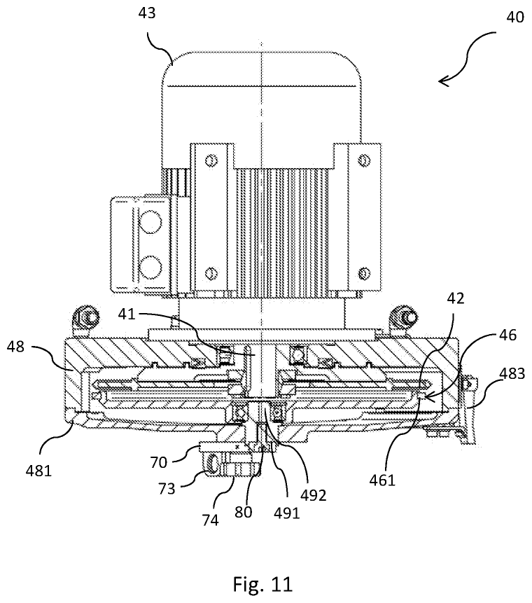

FIG. 11 shows in schematic form a partial longitudinal section through the bevelling unit according to a possible embodiment of the present invention;

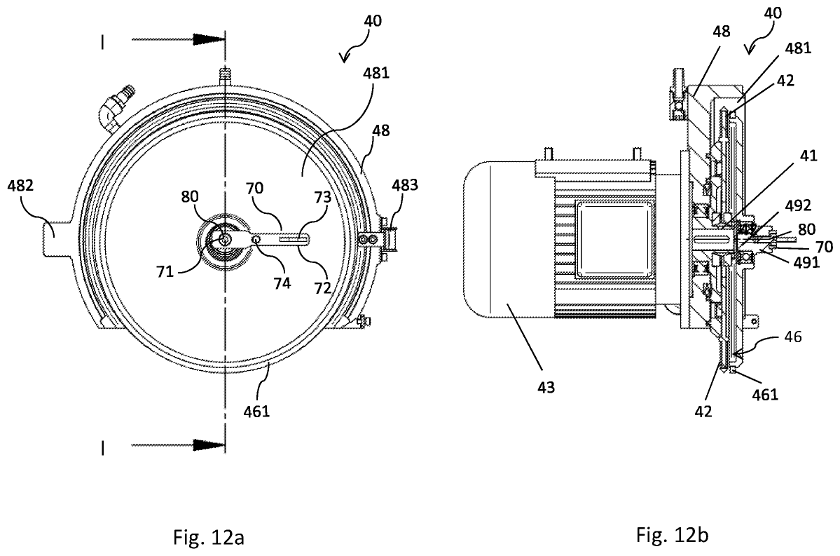

FIG. 12a shows in schematic form a front view of the bevelling unit according to a possible embodiment of the present invention during a possible working configuration;

FIG. 12b shows in schematic form a partial cross-section of FIG. 12a along the cross-sectional plane I-I;

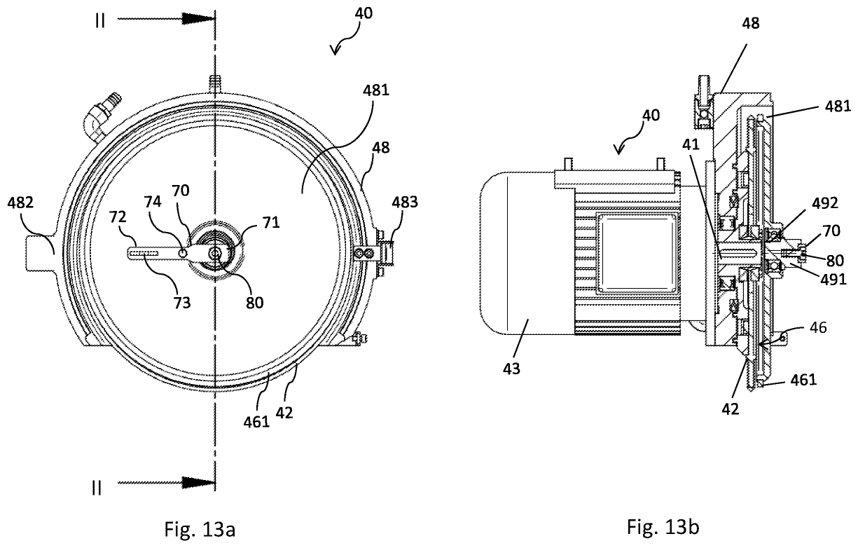

FIG. 13a shows in schematic form a front view of the bevelling unit according to a possible embodiment of the present invention during a possible working configuration;

FIG. 13b shows in schematic form a partial cross-section of FIG. 13a along the cross-sectional plane II-II;

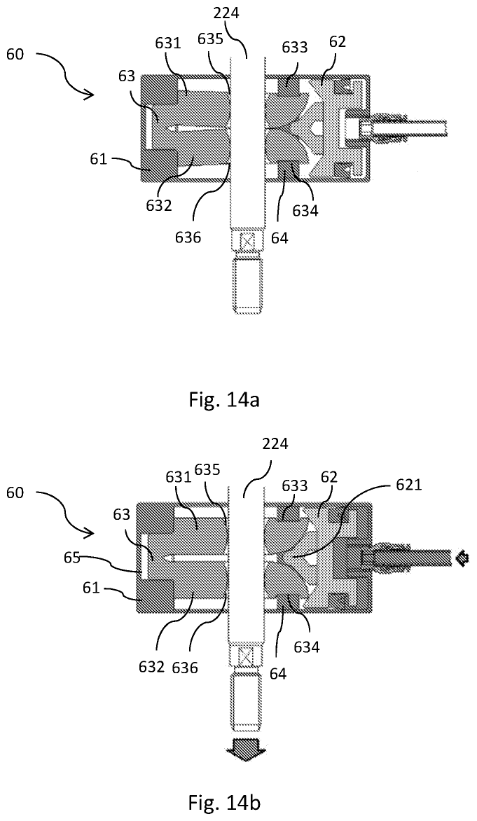

FIG. 14a shows in schematic form a cross-section of a rod locking brake in a possible working configuration;

FIG. 14b shows in schematic form a cross-section of the rod locking brake according to FIG. 14a in a further working configuration.

FIG. 1 shows, denoted by the reference number 10, a combined cutting and bevelling machine for slabs of stone or stone-like material according to the present invention.

The machine 10 comprises at least one work unit 16 provided with a cutting unit 50 and a bevelling unit 40, wherein the cutting unit 50 comprises a cutting spindle 51 and the bevelling unit 40 comprises a bevelling spindle 41.

The cutting spindle 51 is adapted to mount a cutting disc 52. The bevelling spindle 41 is adapted to mount a bevelling disc 42.

The machine 10 comprises a workpiece support bench 30. In accordance with a possible embodiment of the present invention, the workpiece support bench 30 may be rotatable about a vertical axis. Advantageously a drive unit (not shown) may be provided for rotation of the workpiece support bench 30.

Furthermore, the workpiece support bench 30 may be provided with an automated conveyor belt 32 for feeding a slab 31. Advantageously, the conveyor belt 32 may be made of expendable material suitable for receiving incisions.

In accordance with a possible embodiment of the present invention, the at least one work unit 16 may be moved above the workpiece support bench 30 along a beam 12 slidable on two lateral support structures 11, 15. This type of structure, since it is well-known to the person skilled in the art, will not be further described.

According to possible alternative embodiments, other structures for moving the work unit may be provided, such as a robotic arm.

According to a possible embodiment of the present invention, the at least one work unit 16 comprises:
a carriage 13, arranged on the beam 12 and adapted to slide in a horizontal direction along the beam 12; and
a sleeve 14, arranged on the carriage 13 and adapted to slide in a direction perpendicular to the longitudinal direction towards or away from the workpiece support bench 30.

The work unit 16 may also comprise a machining head 20 on which the cutting unit 50 and the bevelling unit 40 may be arranged.

In accordance with alternative embodiments, the cutting unit 50, or the bevelling unit 40, may be arranged directly on the sleeve 14.

In accordance with a possible embodiment of the present invention, the machining head 20 on the sleeve 14 may be replaced with a head adapted to perform only cutting, or with a head adapted to perform only bevelling.

As can be seen in FIG. 2, the machining head 20 comprises a support piece 21 adapted to be connected to the sleeve 14. The cutting spindle 51, on which the cutting disc 52 may be mounted, is housed on the support piece 21. This cutting spindle 51 may be operated by first drive means 53.

In the embodiment shown in FIG. 2, the first drive means 53 comprise an electric motor, which has its axis perpendicular to the workpiece support bench 30.

The support piece 21 is provided with elements designed to connect the support piece 21 to the sleeve 14.

Since the support piece 21 is rigidly connected to the sleeve 14, the machining head 20 is also movable towards or away from the workpiece support bench 30. Advantageously, the machining head 20 moving along this direction is movable between two configurations: a rest configuration (shown in FIG. 4a) and a cutting configuration (shown in FIGS. 4b, 5a, 5b).

The rest configuration is understood as meaning a position of the machining head 20 where the cutting disc 52 is raised from the workpiece support bench 30 and is no longer designed to engage with the slab 31, while a cutting configuration is understood as meaning a position of the machining head 20 where the cutting disc 52 is lowered towards the workpiece support bench 30 and is designed to engage with the slab 31 over the entire thickness of the said slab. In this position, the cutting disc may perform cuts in the expendable support surface on the workpiece support bench 30 to a depth of 1-2 mm.

According to a possible embodiment of the present invention, not shown in the attached figures, the machining head 20 may be adapted to rotate the cutting spindle 51 about a first axis substantially perpendicular to the workpiece support bench 30 and therefore vertical. This allows the machining head 20 to perform cuts in directions inclined in the horizontal plane with respect to the longitudinal direction of the workpiece support bench 30 which coincides with the direction of feeding of the slab 32.

According to an alternative embodiment, the machining head 20 may be a bi-rotational head, i.e. a head adapted to rotate a cutting spindle 51 about a first axis substantially perpendicular to the workpiece support bench 30 and about a second axis, inclined with respect to the first axis. The second axis of rotation may be preferably perpendicular to the first axis. This allows the machining head 20 to perform cuts also in directions inclined with respect to the direction of the first axis, i.e. to the vertical direction. This embodiment of the machining head is not shown in the attached drawings; however it is known per se to the person skilled in the art.

According to a further embodiment, the machining head 20 may be of the fixed direction type. It is clear that a fixed-direction machining head 20 simplifies the constructional design compared to heads which may allow rotation about one or more axes. In this case, the workpiece support bench 30 may be rotatable. In this way, the inability of the machining head 20 to perform transverse cuts is compensated for.

The cutting unit 50, in the vicinity of the cutting disc 51, may be preferably provided with nozzles (not shown in the figures) for dispensing a cooling fluid with the dual function of cooling the cutting disc 52 which may overheat during the cutting step and cleaning the machining waste from the slab 31.

In accordance with a possible embodiment of the present invention, the axis of rotation of the cutting disc 52, which is indicated in the attached figures by the reference number 520, may be parallel to the axis of rotation of the bevelling disc 42, which is indicated in the attached figures by the reference number 420.

Advantageously, the axis of rotation 520 of the cutting disc 52 and the axis of rotation 420 of the bevelling disc 42 may be parallel, but do not coincide.

With reference to the embodiment shown in FIG. 2, the axis of rotation 520 of the cutting disc 52 may be parallel to the axis of rotation 420 of the bevelling disc 42 and moreover the cutting disc 52 and bevelling disc 42 may lie in the same plane. As shown in the configuration of FIG. 8a, the two discs 42 and 52 are aligned so that a bevelling operation and a subsequent cutting operation may be performed without having to reposition the machining head 20.

The machining head 20, in addition to the cutting unit 50, may also comprise the bevelling unit 40.

The bevelling unit 40 comprises the bevelling spindle 41 on which the bevelling disc 42 may be mounted. This bevelling spindle 41 may be operated by second drive means 43.

In the embodiment shown in FIG. 2, the second drive means 43 comprise an electric motor, which has its axis perpendicular to the workpiece support bench 30.

The machining head 20 therefore comprises in a single head both the cutting unit 50 and the bevelling unit 40 with the respective spindles 51 and 41, so as to perform in succession the bevelling step, shown for example in FIG. 6, and a step for cutting the slab 31, shown for example in FIG. 7. In this connection, the machining head 20 must be such that the bevelling unit 40 is positioned in front of the cutting unit 50. In fact, if the cutting operation were to be performed first, followed by the bevelling operation, the tiles cut from the slab 31 could be subject to a relative displacement and therefore might not be situated in an optimum position for the bevelling operation.

In accordance with a possible embodiment of the present invention, the bevelling unit 40 may be connected to the support piece 21 by supporting means 22.

Moreover, the supporting means 22 may allow the movement of the bevelling unit 40 between a retracted configuration and an extracted configuration.

“Retracted configuration” is understood as meaning a configuration in which the bevelling disc 42 is not operative, while “extracted configuration” is understood as meaning an operating condition in which the bevelling disc 42 may cut into a slab 31 being machined.

The movement of the bevelling unit 40 between the two configurations may be performed manually by an operator. For this purpose, locking means (known per se to the person skilled in the art) may be provided for locking the bevelling unit in the two configurations.

Alternatively, the supporting means 22 may comprise a linear actuator 221 designed to move the bevelling unit 40 towards or away from the workpiece support bench 30.

According to a further embodiment, the supporting means 22 comprise a linear actuator 221 which has two ends: a first end 226 connected by means of an actuator hinge 227 to the support piece 21, and a second end 228 connected by means of a second actuator hinge 229 to the bevelling unit 40.

The first actuator hinge 227 may be formed by a bracket which is arranged on the support piece 21 and on which a pin provided on the first end 226 rotates.

The second actuator hinge 229 may consist of a bracket arranged on the bevelling unit 40 and a pin arranged on the second end 228.

Moreover, the supporting means 22 comprise a third hinge 222 between the bevelling unit 40 and the support bracket 22, such that the bevelling unit is adapted to rotate about the axis of the third hinge 222 substantially parallel to the axis of rotation of the bevelling disc.

In the embodiment shown in FIG. 2 the linear actuator 221 is a pneumatic actuator with a cylinder 223 having a rod 224. The cylinder 223 is connected to the support piece by means of the first hinge 227 and the rod 224 is connected to the bevelling unit 40 by means of the second hinge 229.

The retracted configuration of the bevelling unit 40 where the bevelling disc 42 is not operative coincides with retraction of the linear actuator 221, as shown in FIGS. 4a and 4b. During this retraction movement, the rod 224 is sufficiently inserted inside the cylinder 224, forcing the bevelling unit 40 to rotate along a curved arc away from the workpiece support bench 30. The bevelling unit 40 moves until it reaches a retracted configuration.

The operative configuration of the bevelling unit 40, where the bevelling disc 42 may cut into a slab 30, coincides with extension of the linear actuator 221, as shown in FIGS. 5a and 5b. During said extension, the rod 224 is displaced, extending outwards relative to the cylinder 223, forcing the bevelling unit 40 to rotate along a curved arc towards the workpiece support bench 30 about the axis of the third hinge 222. The bevelling unit 40 moves until it reaches an operative configuration.

The extracted and retracted configurations of the bevelling unit 40 may be combined with the movement of the whole machining head 20 between a rest configuration and a cutting configuration.

A configuration is possible where the machining head 20 is in the rest configuration and the bevelling unit 40 is the retracted configuration (FIG. 4a).

Another configuration is also possible where the machining head 20 is in the cutting configuration and the bevelling unit 40 is the retracted configuration (FIG. 4b).

A further configuration is possible where the machining head 20 is in the cutting configuration and the bevelling unit 40 is the extracted configuration (FIGS. 5a and 5b). It is clear that in this configuration at the start of machining of the slab 31, only the bevelling disc 42 will engage the slab 31 (FIG. 5a) and only subsequently, for example with the advancing movement of the machining head 20 along the direction of the beam 12, also the cutting disc 52 will engage with the slab 31 (FIG. 5b).

Should it be necessary to use only the cutting disc 52 and not the bevelling disc 42, the machining head 20 may assume the cutting configuration with the bevelling unit 40 in the retracted configuration (FIGS. 4a, 4b).

In accordance with a possible embodiment of the present invention, the rod 224 may be covered by a protection piece 225 adapted to prevent the entry into the cylinder 223 of any waste matter produced by machining.

According to a possible embodiment of the present invention, the bevelling unit 40 may be provided with a protection element or cowl 48 (see for example FIG. 9).

In accordance with a possible embodiment of the present invention, the protection element or cowl 48 may be opened so as to allow access in order to service or replace the bevelling disc 42. Advantageously the protection element or cowl 48 may be provided with a hatch 481 rotatable about the cowl hinges 482 and kept in a closed position by locking elements 483.

According to a possible embodiment of the present invention, the bevelling unit 40 may be provided with nozzles for dispensing a cooling fluid with the dual function of cooling the bevelling disc 42 which may overheat during a bevelling step and cleaning the machining waste from the slab 31. According to a possible embodiment of the present invention, the bevelling unit 40 may be provided with locating or adjustment means 46. The locating means 46 allow a constant distance to be kept between the surface of the slab 31 being machined and the axis of rotation of the bevelling disc 42.

It is therefore clear that the locating means 46 act so that the depth of the incision made by the bevelling disc 42 is always that pre-set by the operator and remains constant for the whole of the machining operation. In this way, the locating means 46 are able to compensate for any variations in the thickness of the slab 31 which occur during the advancing movement of the machining head 20.

According to a possible embodiment of the present invention, the locating means 46 may comprise optical means, such as a laser spacing meter.

According to another possible embodiment of the present invention, the locating means 46 may comprise a rubberized wheel 461.

In the embodiment shown in FIG. 8 and FIG. 8a, the rubberized wheel 461 is located alongside the bevelling disc 42.

Advantageously the rubberized wheel 461 may be mounted idle.

The rubberized wheel 461 may be made to move by the movement of the machining head 20. In FIG. 12b and FIG. 13b it can be noted that the position of the rubberized wheel 461 may be adjusted along a direction substantially perpendicular to the workpiece support bench 30. Consequently, the relative position of the rubberized wheel 461 with respect to the bevelling disc 42, and in particular with respect to its bottom edge, may therefore be varied. As a result it is possible to define a plurality of different depths of the incision made by the bevelling disc 42.

According to a possible embodiment of the present invention, the adjustment of the position of the rubberized wheel 461 with respect to the bevelling disc 42 may be performed manually by an operator.

The adjustment of the position of the rubberized wheel 461 with respect to the bevelling disc 42 may be performed by means of an eccentric pin 49. In FIGS. 10a and 10b it can be noted that the eccentric pin 49 may comprise a first part 491 and a second part 492, which are both cylindrical, the first part 491 and the second part 492 having axes which are parallel, but do not coincide.

According to a possible embodiment of the present invention, the eccentric pin 49 may be mounted on the shaft on which the bevelling disc 42 is mounted.

Alternatively, the eccentric pin 49 may be mounted on the protection element or cowl 48. In particular, the first part 491 of the eccentric pin 49 may be adapted to engage with the protection element or cowl 48 of the bevelling unit 40.

In accordance with a possible embodiment, the hatch 481 of the protection element or cowl 48 may be provided with a through-hole 485 inside which the first part 491 of the eccentric pin 49 may be seated.

The through-hole 485 may be coaxial with the axis of rotation of the bevelling disc 42. It is evident that, when the first part 491 rotates, the second part 492 also rotates, but eccentrically with respect to the first part 491. By so doing, the second part 492 may assume different relative positions with respect to the axis of rotation of the bevelling disc 42. Advantageously, the rubberized wheel 461 may be mounted on the second part 492.

According to an embodiment, the first part 491, in order to be rotationally guided, may comprise a bottom surface 493 having a recess 494, formed by containing edges 495, 496, and a hole 497, positioned in the centre of the bottom surface 493 (see FIGS. 10a and 10b).

The recess 491 is adapted to seat a first end 71 of a lever 70 which also has a second free end 72. The first end 71 is pivotably mounted by means of fixing means 80, the shank of which is received inside the hole 497. Owing to the cooperation between the fixing means 80 and containing edges 495, 496, the first end 71 of the lever 70 is locked together with the first part 491 of the eccentric pin 49. It is clear that, when the second end 72 is operated, the lever 70 rotates and, at the same time, the first part 491 and the second part 492 of the eccentric pin 49 also rotate, the second part 492 rotating eccentrically with respect to the first part 491 and the lever 70.

The second end 71 of the lever 70 may be provided with a ring-type gripping handle 73 in order to facilitate movement of the lever 70.

Moreover, the lever 70 may be provided with a control knob 74 provided with a pin adapted to engage with holes 486 formed in the protection element 48 and positioned along a circumference having its centre coinciding with the centre of the bottom surface 493 of the first part 491 of the eccentric pin 49.

In this way, for heightwise adjustment of the rubberized wheel 461, the following steps must be performed:
unscrewing the control knob 74 so as to release the lever 70,
rotating the lever by operating the second end 72, displacing or raising the rubberized wheel 461;
locking the lever 70 by screwing the control knob 74 inside one of the holes 486, when the rubberized wheel is in the required position.

In this way it is possible to arrange the rubberized wheel 461 in a predefined heightwise position with respect to the bevelling disc 42.

In accordance with a possible embodiment, the movement of the bevelling unit 40 may be further controlled by means of a rod locking brake 60.

As can be seen in FIGS. 14a and 14b, the brake 60 is formed by a pneumatic cylinder 61 provided with a chamber 65 containing a piston 62, provided with a wedge-shaped portion 621, and a U-shaped element 63, provided with first and second flanges 631, 632, between which the wedge-shaped portion 621 is able to slide.

Opposite the flanges 631, 632, coaxial holes 633, 634 extending in a direction substantially perpendicular to the direction of the piston 62 are provided. The coaxial holes 633, 634 are adapted to receive a guide rod 64 adapted to guide the first and second flanges 631, 632 towards or away from each other.

The flanges 631, 632 are also provided with tapered holes 635, 636 which are substantially parallel to the coaxial holes 633, 634 and inside which the rod 224 of the linear actuator 221 slides.

In the case where the cylinder 61 is not energized, the piston 62 does not act on the first and second flanges 631, 632 which are therefore inclined with respect to each other, locking the rod 224 owing to the friction which is generated between the tapered holes 635, 636 and the rod 224 itself (FIG. 14a). In this way, by locking the rod 224, the bevelling unit 40 may also be locked in a predetermined position.

If the cylinder 61 is energized, the piston 62 via its wedge-shaped portion 621 (FIG. 14b) acts on the first and second flanges 631, 632, splaying them. This results in slackening of the friction between the tapered holes 635, 636 and the rod 224, allowing the rod 224 to slide freely and therefore the bevelling unit 40 to be moved.

Advantageously, the presence of the rod locking brake 60 ensures that the bevelling unit 40, when it is in the extracted position and removed from the slab at the end of the bevelling step, does not move downwards suddenly and cut into the conveyor belt 32. This because the rod locking brake 60 is energized and therefore the rod 224 is able to slide freely during machining, allowing the rubberized wheel 461 to rest constantly against the surface of the slab, rolling thereon; when the unit is removed from the slab, the brake is locked and therefore sudden lowering is prevented.

The above description clearly highlights the characteristic features of the combined cutting and bevelling machine for slabs of stone or stone-like material according to the present invention, as well as the associated advantages.

Further variants of the embodiments described above are possible, without departing from the teaching of the invention.

1. Combined cutting and bevelling machine (10) for slabs of stone or stone-like material, comprising a workpiece support bench (30) and at least one work unit (16) provided with a cutting unit (50) and a bevelling unit (40), wherein the cutting unit (50) comprises a cutting spindle (51) adapted to mount a cutting disc (52) and the bevelling unit (40) comprises a bevelling spindle (41) adapted to mount a bevelling disc,
characterized in that the cutting disc (521) and the bevelling disc (42) lie in the same plane.

2. Combined cutting and bevelling machine (10) according to claim 1, characterized in that it comprises a workpiece support bench (30) rotatable about a vertical axis.

3. Combined cutting and bevelling machine (10) according to claim 1, characterized in that said at least one work unit (16) comprises a machining head (20) equipped with the cutting unit (50) and with the bevelling unit (40).

4. Combined cutting and bevelling machine (10) according to claim 3, characterized in that the machining head (20) is of the fixed-direction type or of the type able to be directed with respect to a vertical axis.

5. Combined cutting and bevelling machine (10) according to either one of claims 3-4, characterized in that the machining head (20) comprises a support piece (21) which houses the cutting spindle (51) adapted to mount the cutting disc (52); said support piece having mounted thereon via supporting means the bevelling unit (40) comprising the bevelling spindle (41) adapted to mount the bevelling disc (42).

6. Combined cutting and bevelling machine (10) according to claim 5, characterized in that the supporting means (22) allow movement of the bevelling unit (40) between a retracted configuration and an extracted configuration.

7. Combined cutting and bevelling machine (10) according to either one of claims 5-6, characterized in that the supporting means (22) comprise a linear actuator (221) which has two ends: a first end (226) connected via a first actuator hinge (227) to the support piece (21), and a second end (228) connected via a second support hinge (228) to the bevelling unit (40); said supporting means (22) further comprise a third hinge (222) between the bevelling unit (40) and the supporting means (22), such that the bevelling unit (40) is adapted to rotate about the axis of the third hinge substantially parallel to the axis of rotation (420) of the bevelling disc (40),

8. Combined cutting and bevelling machine (10) according to claim 1, characterized in that the bevelling unit (40) is provided with a protection element or cowl (48) having a hatch (481) rotatable about cowl hinges (482) and kept in the closed position by locking elements (483).

9. Combined cutting and bevelling machine (10) according to claim 2, characterized in that the at least one work unit (16) is movable in the longitudinal and transverse direction above the workpiece support bench (30).

10. Combined cutting and bevelling machine (10) according to claim 2, characterized in that the at least one work unit (16) is movable towards or away from the workpiece support bench (30).

11. Combined cutting and bevelling machine (10) according to claim 5, characterized in that the axis of rotation (520) of the cutting disc (52) and the axis of rotation (420) of the bevelling disc (42) are parallel to each other, but do not coincide.

12. Combined cutting and bevelling machine (10) according to any one of the preceding claims, characterized in that the bevelling unit (40) may be provided with adjustment means (46) which allow a constant distance to be maintained between the surface of a slab (31) being machined and the axis of rotation (420) of the bevelling disc (42).

13. Combined cutting and bevelling machine (10) according to claim 12, characterized in that the adjustment means (46) comprise a rubberized wheel (461) situated alongside the bevelling disc (42).

14. Combined cutting and bevelling machine (10) according to claim 13, characterized in that the position of the rubberized wheel (461) may be adjusted along a direction substantially perpendicular to the workpiece support bench (30).

15. Combined cutting and bevelling machine (10) according to claim 14, characterized in that the position of the rubberized wheel (461) is adjustable by means of an eccentric pin (49); said eccentric pin (49) comprising a first part (491) adapted to engage with the protection element (48) of the bevelling unit (40), and a second part (492) on which the rubberized wheel (461) is mounted.

16. Combined cutting and bevelling machine (10) according to claim 15, characterized in that the first part (491) of the eccentric pin (49) is moved by a lever (70).

17. Combined cutting and bevelling machine (10) according to claim 16, characterized in that the lever (70) is provided with a control knob (74) adapted to engage with holes (486) positioned along a circumference having its centre coinciding with the centre of a bottom surface (493) of the first part (491) of the eccentric pin (49).
